(19) United States
(12) Patent Application Publication
(10) Pub. No.: US 2020/0163025 A1
(43) Pub. Date: May 21, 2020

(54) USER TERMINAL AND RADIO COMMUNICATION METHOD

(71) Applicant: NTT DOCOMO, INC., Tokyo (JP)

(72) Inventor: Ryosuke Osawa, Tokyo (JP)

(73) Assignee: NTT DOCOMO, INC., Tokyo (JP)

(21) Appl. No.: 16/636,144

(22) PCT Filed: Aug. 4, 2017
(86) PCT No.: PCT/JP2017/028492

§ 371 Date: Feb. 3, 2020

(51) Int. Cl. H04W 52/14; H04W 52/02

(52) U.S. Cl. CPC H04W 52/146; H04W 52/0209

(57) ABSTRACT

A user terminal according to one aspect of the present disclosure is characterized by having a control section that applies power reduction to transmit power in a given carrier, and a transmitting section that transmits a given signal using transmit power applied with the power reduction. According to one aspect of the present disclosure, it is possible to suppress degradation in communication throughput and the like, also in the case of performing power reduction.

### TECHNICAL FIELD

The present disclosure relates to a user terminal and radio communication method in the next-generation mobile communication system.

### BACKGROUND ART

In Universal Mobile Telecommunications System (UMTS) networks, for the purpose of higher data rates, low delay and the like, Long Term Evolution (LTE) has been specified (Non-patent Document 1). Further, for the purpose of higher capacity and more sophistication than LTE (LTE Rel.8, 9), LTE-Advanced (LTE-A, LTE Rel. 10, 11, 12, 13) has been specified.

Successor systems (e.g., also referred to as Future Radio Access (FRA), 5th generation mobile communication system (5G), 5G+(plus), New Radio (NR), New radio access (NX), Future generation radio access (FX) LTE Re1.14 or 15 onward, etc.) to LTE have also been studied.

In existing LTE (e.g., LTE Re1.8-13), a user terminal (UE: User Equipment) transmits a power headroom report (PHR) including information on uplink power headroom (PH) for each serving cell to an apparatus (e.g., base station) on the network side as feedback.

The base station judges uplink transmit power of the UE based on the PHR, and performs notification of a transmit power control (TPC) command and the like to the UE so as to obtain proper uplink transmit power.

### PRIOR ART DOCUMENT

### Non-Patent Document

[Non-patent Document 1] 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April, 2010

### DISCLOSURE OF INVENTION

### Problems to be Solved by the Invention

In the future radio communication system (e.g., NR), it is considered that a base station is not capable of correctly grasping transmit power of a UE based on PH, and that transmit power control of the UE is not properly performed. As a result, there is the risk that deterioration of communication throughput, spectral efficiency and the like occurs.

Therefore, it is an object of the present disclosure to provide a user terminal and radio communication method capable of suppressing degradation in communication throughput and the like, also in the case of performing power reduction.

### Means for Solving the Problem

A user terminal according to one aspect of the present disclosure is characterized by having a control section that applies power reduction to transmit power in a given carrier, and a transmitting section that transmits a given signal using transmit power applied with the power reduction.

### Advantageous Effect of the Invention

According to one aspect of the present disclosure, it is possible to suppress degradation in communication throughput and the like, also in the case of performing power reduction.

### BRIEF DESCRIPTION OF DRAWINGS

FIGS. 1A and 1B are explanatory diagrams of descriptions of power reduction information in Embodiment 1;

FIG. 2 is a diagram showing one example of a flow of processing in the case of combining Embodiments 1 and 3;

FIG. 3 is diagram showing one example of a schematic configuration of a radio communication system according to one Embodiment;

FIG. 4 is a diagram showing one example of an entire configuration of a radio base station according to one Embodiment;

FIG. 5 is a diagram showing one example of a function configuration of the radio base station according to one Embodiment;

FIG. 6 is a diagram showing one example of an entire configuration of a user terminal according to one Embodiment;

FIG. 7 is a diagram showing one example of a function configuration of the user terminal according to one Embodiment; and

FIG. 8 is a diagram showing one example of hardware configurations of the radio base station and user terminal according to one Embodiment.

### BEST MODE FOR CARRYING OUT THE INVENTION

On uplink of existing LTE (e.g., LTE Rel. 8-13), open loop transmit power control and closed loop transmit power control is supported.

In uplink transmit power control of LTE, an error in open loop control is corrected by closed loop control using a transmit power control (TPC) command received from a base station.

For example, targets for transmit power control are transmit power of an uplink shared channel (PUSCH: Physical Uplink Shared Channel), uplink control channel (PUCCH: Physical Uplink Control Channel), uplink measurement reference signal (SRS: Sounding Reference Signal) and the like.

In transmit power control, maximum transmit power (P_{CMAX, c}) per serving cell (component carrier (CC)) is used. P_{CMAX, c} is a value determined by a UE from a range between a given upper limit and a given lower limit, and may be called allowable maximum power per CC and the like.

Specifically, in existing LIE, P_{CMAX, c} is configured for each subframe by the UE so that P_{CMAX_L, c}≤P_{CMAX, c}≤P_{CMAX_H, c}. For example, each of the upper limit P_{CMAX_H, c} and lower limit P_{CMAX_L, c} is defined as described below.

P_{CMAX_H,c}=MIN {P_{EMAX,c},P_{PowerClass}} Equation (1)

P_{CMAX_L,c}=MIN {P_{EMAX,c}−ΔT_{C,c},P_{PowerClass}−MAX(MPR_{c}+A−MPR_{c}+ΔT_{IB,}+_{c}+ΔT_{C,c},P-MPR_{c})} Equation (2)

Herein, P_{EMAX, c} is a value determined by higher layer signaling (e.g., broadcast signal), and P_{PowerClass} is a specified value and may vary with carrier. ΔT_{C, c} and ΔT_{IB, c} are offset values, and for example, may be determined to absorb an error for each UE.

MPR_{c} is a maximum power reduction in the serving cell, and is a variable value corresponding to Modulation and Coding Scheme (MCS), the number of Physical Resource Blocks (PRBs) and the like. A-MPR_{c} is an additional maximum power reduction (Additional MPR). P-MPR_{c} is a value used in power management. In addition, MIN and MAX represent functions for extracting a minimum value and maximum value of an argument list, respectively.

For example, the power reduction is performed to control unnecessary radiation (may be called Electro Magnetic Interference (EMI), etc.) to within a given value or less. In addition, in the present Description, in the case of simply describing “power reduction”, the “power reduction” may be read with “maximum power reduction”.

The upper limit P_{CMAX_H, c} is determined by P_{EMAX, c} or specified value P_{PowerClass}, and therefore, does not vary. On the other hand, the lower limit P_{CMAX_L, c} is variable with MPR. Further, the MPR varies by MCS, the number of PRBs and the like, and has a possibility of varying with a lapse of time. Accordingly, the P_{CMAX, c} determined as a value between these upper limit and lower limit has a possibility of varying with a lapse of time. Further, the P_{CMAX} also has a possibility of varying with a lapse of time.

The P_{CMAX, c} has the possibility of varying with a lapse of time. Further, the P_{CMAX} also has the possibility of varying similarly.

In addition, in existing LTE, a UE transmits a power headroom report (PHR) including information on uplink power headroom (PH) for each serving cell to an apparatus (e.g., base station) on the network side as feedback.

The base station judges uplink transmit power of the UE based on the PHR, and estimates an uplink path loss. Based on information on the path loss, the base station performs, on the UE, configurations of target Signal to Interference plus Noise Ratio (SINR), transmit power parameter and the like, notification of a TPC command and the like, and controls to obtain proper uplink transmit power.

There is the case where the UE calculates the PH based on the above-mentioned P_{CMAX, c} and the PHR includes the P_{CMAX, c}. However, in NR, in order to reduce information amounts, it is studied that the P_{CMAX, c} is not transmitted to the base station, and the like. In this case, the base station is not capable of correctly grasping transmit power of the UE based on the PH, and there is the risk that transmit power control of the UE is not properly performed. As a result, there is the risk that deterioration of communication throughput, spectral efficiency and the like occurs.

Therefore, the inventor of the present invention conceived the method of suitably performing transmit power control of a UE, also in the case of performing power reduction.

Embodiments will be described below in detail with reference to drawings. A radio communication method according to each of the Embodiments may be applied alone, or may be applied in combination.

In addition, a “signal” appearing in the following description may be read with a “channel”, “signal and/or channel” and the like.

### Radio Communication Method

### Embodiment 1

In Embodiment 1, a UE reports (transmits) information (may be called power reduction information and the like) on power reduction applied to a transmission signal to a base station.

The power reduction information may indicate a value about power reduction. For example, the power reduction information may indicate a value of MAX (MPR_{c}+A-MPR_{c}+ΔT_{IB, c}+ΔT_{C, c}, P-MPR_{c}), or may indicate one or a plurality of values among MPR_{c}, A-MPR_{c}, ΔT_{IB, c}, ΔT_{C, c} and P-MPR_{c}. The power reduction information may indicate a value of power that is actually reduced using a given reference value (e.g., P_{CMAX_H, c}, P_{EMAX, c}, P_{PowerClass} or a value obtained applying given calculation to these values) as reference.

The power reduction value may include power reduction information for each CC (or on a particular CC), may include power reduction information common to a plurality of CCs, or may include power reduction information obtained by integrating a plurality of CCs.

In the case where power reduction is not performed, the UE may not report the power reduction information. In the case of reporting the power reduction information, the UE may assume that information on P_{CMAX, c} is not transmitted to the base station.

The power reduction information may be represented by a value in a given unit (e.g., decibel (dB), dBm, etc.), or may be represented by a value of an index associated with a value in a given unit. The number of bits of the index, correspondence between the index and the value in the given unit and the like may be configured for the UE by higher layer signaling and the like, or may be beforehand defined by specifications. For example, the power reduction information may be information with the number of bits lower than 6 bits.

The UE may transmit the power reduction information by higher layer signaling, physical layer signaling (e.g., uplink control information (UCI)) or combination thereof.

In the higher layer signaling, for example, RRC (Radio Resource Control) signaling, Medium Access Control (MAC) signaling (e.g., MAC control element (MAC CE (Control Element))) and the like may be used.

The power reduction information may be included in the PHR (may be reported at the same timing as the PHR), or may be reported differently from the PHR (may be reported at timing different from the PHR).

In addition, power reduction may be performed on transmit power of a particular uplink signal. For example, the UE may perform power reduction on one or a plurality of respective transmit power of SRS, DeModulation Reference Signal (DMRS), PUSCH and PUCCH. In this case, the power reduction information may include power reduction information for each signal (or on a particular signal), may include power reduction information common to a plurality of signals, or may include power reduction information obtained by integrating a plurality of signals.

The power reduction information may include information on an applied uplink signal (e.g., SRS, DMRS, PUSCH, PUCCH). Based on the information on the applied uplink signal, the base station may judge the uplink signal targeted for power reduction.

The uplink signal targeted power reduction may be configured for the UE by higher layer signaling, or may be defined by specification.

A report of the power reduction information may be performed based on a report instruction (may be called a report trigger and like). The base station may transmit the report instruction for instructing the UE to report the power reduction information. The base station may transmit the report instruction, using higher layer signaling (e.g., RRC signaling, MAC signaling, broadcast information (e.g., Master Information Block (MIB), System Information Block (SIB))), physical layer signaling (e.g., downlink control information (DCI)), or combination thereof.

The report instruction may include information on time and/or frequency resources for the report. For example, the report instruction may include information on a timing offset from reception of the report instruction to transmission of the report, the number of PRBs and the like.

After receiving the report instruction, the UE may report the power reduction information periodically, may report the given number of times (e.g., once), or may report at timing meeting a given condition. The given condition may be notified using the report instruction, may be notified using another signaling (e.g., RRC signaling), or may be defined by specifications. In the case of receiving information for instructing the UE to halt the report, the UE may halt the report.

The UE may report the power reduction information at timing at which power reduction is performed on a signal of any of CCs. At timing at which power reduction of a given value (e.g., X dB) or more is performed, the UE may report the power reduction information. The given value may be defined by specifications, or may be notified with the above-mentioned report instruction. Also when the report instruction is not received, the UE may report the power reduction information autonomously.

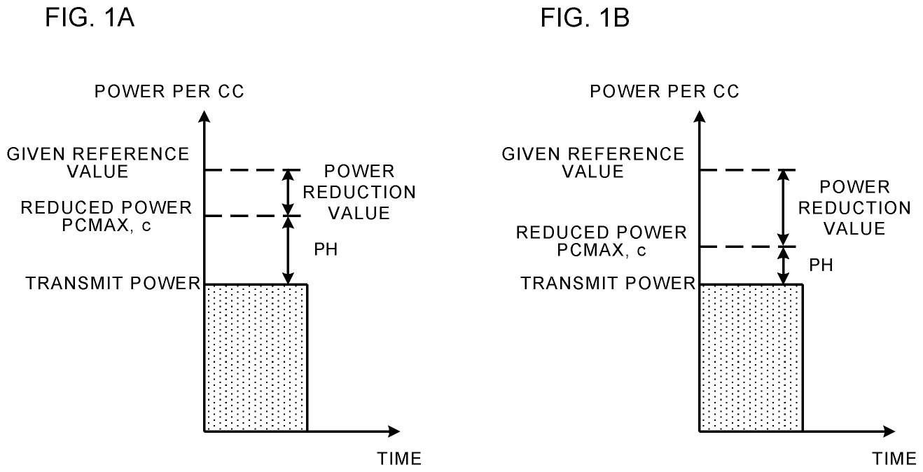

FIGS. 1A and 1B are explanatory diagrams of descriptions of the power reduction information in Embodiment 1. Each diagram illustrates actual transmit power of a signal in a given time unit (e.g., slot, mini slot, subframe) and P_{CMAX, c} at the same time.

With respect to P_{CMAX, c}, a value in the case where power reduction is not performed and a value subjected to power limitations actually at the transmission timing are shown by dashed lines. In FIGS. 1A and 1B, the power reduction values are different, and transmit power is the same.

The UE calculates the PH based on the power-reduced P_{CMAX, c} to report to the base station. When the base station assumes that the PH reported from the UE is calculated based on the P_{CMAX, c} of the case of being not subjected to power reduction, the base station erroneously recognizes transmit power of the UE.

On the other hand, in the case where the UE includes the power reduction value in the power reduction information to report to the base station, based on the reported PH and power reduction information, the base station is capable of properly grasping transmit power of the UE (capable of determining a difference between FIGS. 1A and 1B).

According to Embodiment 1 as described above, the base station is capable of correctly grasping the information on transmit power of the UE, and is capable of performing proper transmit power control.

### Embodiment 2

In Embodiment 2, a UE reports (transmits) information (may be called maximum transmit power information and the like) on current maximum transmit power to a base station.

For example, the maximum transmit power information may indicate one or a plurality of values among P_{CMAX, c}, lower limit value (P_{CMAX_L, c}) of P_{CMAX, c}, and upper limit value (P_{CMAX_H, c}) of P_{CMAX, c}. The maximum transmit power information may be a difference (or offset) with reference to a given value.

The maximum transmit power information may include information for each CC (or on a particular CC), may include information common to a plurality of CCs, or may include information obtained by integrating a plurality of CCs.

The maximum transmit power information may be represented by a value in a given unit (e.g., dB, dBm, etc.), or may be represented by a value of an index associated with a value in a given unit. The number of bits of the index, correspondence between the index and the value in the given unit and the like may be configured for the UE by higher layer signaling and the like, or may be beforehand defined by specifications.

The UE may transmit the maximum transmit power information by higher layer signaling (e.g., RRC signaling, MAC signaling, SIB), physical layer signaling (e.g., UCI) or combination thereof.

The maximum transmit power information may be included in the PHR (may be reported at the same timing as the PHR), or may be reported differently from the PHR (may be reported at timing different from the PHR).

In addition, the maximum transmit power information may include maximum transmit power information for each uplink signal (e.g., SRS, DMRS, PUSCH, PUCCH) (or on a particular signal), may include maximum transmit power information common to a plurality of signals, or may include maximum transmit power information obtained by integrating a plurality of signals.

The maximum transmit power information may include information on an applied uplink signal (e.g., SRS, DMRS, PUSCH, PUCCH). Based on the information on the applied uplink signal, the base station may judge the uplink signal targeted for power reduction.

A report of the maximum transmit power information may be performed based on a report instruction. The base station may transmit the report instruction for instructing the UE to report the maximum transmit power information. The base station may transmit the report instruction, using higher layer signaling (e.g., RRC signaling, MAC signaling, SIB), physical layer signaling (e.g., DCI), or combination thereof.

The report instruction may include information on time and/or frequency resources for the report. For example, the report instruction may include information on a timing offset from reception of the report instruction to transmission of the report, the number of PRBs and the like.

After receiving the report instruction, the UE may report the maximum transmit power information periodically, may report the given number of times (e.g., once), or may report at timing meeting a given condition. The given condition may be notified using the report instruction, or may be defined by specifications. In the case of receiving information for instructing the UE to halt the report, the UE may halt the report.

The UE may report the maximum transmit power information at timing at which power reduction is performed on a signal of any of CCs. At timing at which power reduction of a given value (e.g., X dB) or more is performed, the UE may report the maximum transmit power information. The given value may be defined by specifications, may be notified using another signaling (e.g., RRC signaling), or may be notified with the above-mentioned report instruction. Also when the report instruction is not received, the UE may report the maximum transmit power information autonomously.

According to Embodiment 2 as described above, the base station is capable of correctly grasping the information on transmit power of the UE, and is capable of performing proper transmit power control.

### Embodiment 3

In Embodiment 3, a base station transmits information (transmit power designation information) for designating transmit power of a given signal to a UE.

Upon receiving the transmit power designation information, the UE may control transmit power of a given signal to a value indicated by the information. The UE may apply power reduction to the transmit power.

In this case, the UE may reset (e.g., may set at a given value (e.g., “0”)) a correction value based on the TPC command (e.g., cumulative value of TPC commands, offset amount based on the TPC command, etc.) for the given signal, or may accept without modification (may use continuously). In determining transmit power of the given signal based on the transmit power designation information, the UE may consider a correction value based on the TPC command about the given signal. In addition, the correction value may be understood as f_{c}(i) in the uplink transmit power calculation equation in existing LTE or as a value obtained by applying extension, modification or the like to f_{c}(i).

For example, in order to adjust to power designated by the transmit power designation information, the UE may reset the above-mentioned correction value, and add/subtract a difference between the designated power and current (or immediately before) transmit power to/from P₀ and/or PL_{c}. In addition, in the case of adding/subtracting PL_{c}, it is preferable to adjust in consideration of α.

Herein, P₀ may be a value (e.g., when the given signal is PUSCH, P_{O_PUSCH, c} (j)) indicative of a target received power equivalence of the given signal, PL_{c} may be a path loss on downlink calculated by the UE, and α may be a coefficient to multiply PL_{c}. These parameters may be understood as parameters in the uplink transmission power calculation equation in existing LTE, or values obtained by applying extension, modification or the like to the parameters.

In order to adjust to power designated by the transmit power designation information, the UE may not reset the above-mentioned correction value, and may add/subtract a difference from current (or immediately before) transmit power to/from the above-mentioned correction value. The transmit power designation information may include information on whether or not to reset the above-mentioned correction value.

The UE may assume that power designated by the transmit power designation information is independent of ordinary power control. In this case, also in the case of receiving the transmit power designation information, the UE may hold power control parameters such as the above-mentioned correction value used in ordinary power control. After transmitting the given signal for a certain period using transmit power based on the transmit power designation information, the UE may return to ordinary power control.

Without using a value indicated by the transmit power designation information in actual signal transmission, the UE may use the value in calculation of path loss and/or PH. The transmit power designation information may be called power information for path loss calculation, power information for PH calculation and the like.

For example, based on transmit power designated by the transmit power designation information and a transmit power parameter set except PL_{c}, the UE may calculate a path loss on downlink. Herein, the transmit power parameter set may be a parameter set used in transmit power calculation of a signal, and for example, includes parameters such as P_{O} and α.

In this case, the transmit power designation information may include information on whether or not to reset the above-mentioned correction value, information for designating the above-mentioned correction value and the like. By this means, it is possible to support the case where recognition of the above-mentioned correction value is different between the UE and the base station (e.g., the case where the UE fails to receive a TPC command, and the like).

Based on the transmit power designation information, the UE may reset the above-mentioned correction value, or may set at a designated value. In addition, in the case of resetting the above-mentioned correction value, the base station may configure a value obtained by adding a value of the correction value before resetting to P₀ as renewed P₀ for the UE differently by higher layer signaling and the like, or may include such a value in the transmit power designation information to notify.

In addition, in the case where the base station transmits the transmit power designation information so as to cause the UE to calculate a path loss on downlink, the base station may calculate transmit power of the UE, based on a beforehand measured path loss on uplink.

The transmit power designation information may be represented by a value in a given unit (e.g., dB, dBm, etc.), or may be represented by a value of an index associated with a value in a given unit. The number of bits of the index, correspondence between the index and the value in the given unit and the like may be configured for the UE by higher layer signaling and the like, or may be beforehand defined by specifications.

The base station may designate a value indicated by the transmit power designation information in a range that does not exceed P_{CMAX, c} or P_{CMAX_L, c}.

The transmit power designation information may include transmit power designation information for each CC (or on a particular CC), may include transmit power designation information common to a plurality of CCs, or may include transmit power designation information obtained by integrating a plurality of CCs.

The base station may transmit the transmit power designation information by higher layer signaling (e.g., RRC signaling, MAC signaling, SIB), physical layer signaling (e.g., DCI) or combination thereof.

The transmit power designation information may be used in determining transmit power (and/or PH) of a particular uplink signal. For example, the UE may use the transmit power designation information in transmit power determination in one or more among SRS, DeModulation Reference Signal (DMRS), PUSCH and PUCCH.

The transmit power designation information may include information on an applied uplink signal (e.g., SRS, DMRS, PUSCH, PUCCH). Based on the information on the applied uplink signal, the UE may judge the uplink signal to judge transmit power based on the transmit power designation information.

The target uplink signal power of which is designated by the transmit power designation information may be defined by specifications.

According to Embodiment 3 as described above, the base station is capable of correctly grasping the information on transmit power of the UE, and is capable of performing proper transmit power control.

### <Modification>

A plurality of Embodiments described above may be used in combination. For example, the case of combining Embodiments 1 and 3 will be described below.

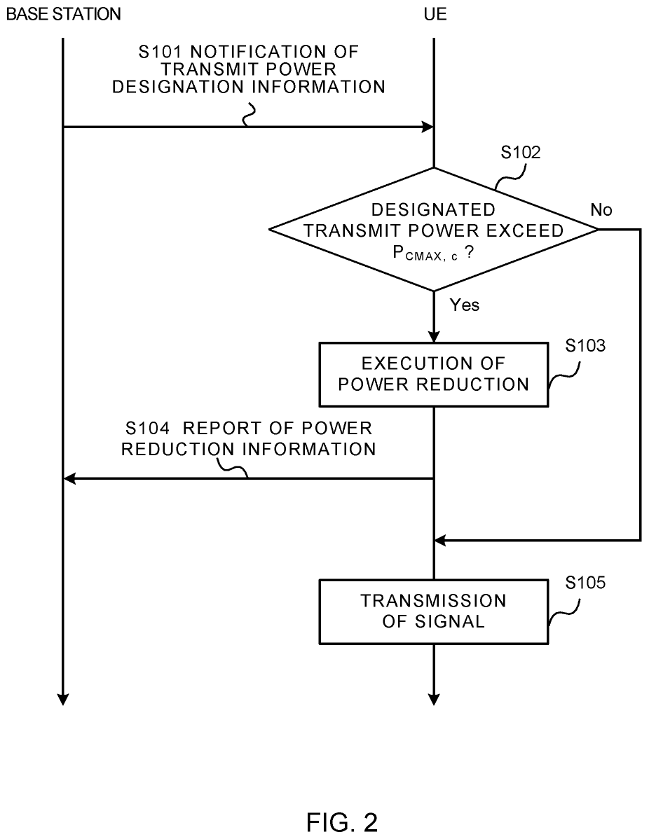

FIG. 2 is a diagram showing one example of a flow of processing in the case of combining Embodiments 1 and 3. In this example, transmit power of a given CC is indicated from the base station to the UE.

In step S101 in FIG. 2, the base station notifies the UE of the transmit power designation information shown Embodiment 3. The transmit power designation information may include information on an applied uplink signal.

In step S102, the UE determines whether or not transmit power designated by the above-mentioned transmit power designation information exceeds maximum allowable transmit power (P_{CMAX, c}) of a corresponding CC. In the case where a result of the determination is true (Yes), in step S103, the UE performs power reduction so that the designated transmit power is the maximum allowable transmit power or less.

In step S104, the UE reports, to the base station, power reduction information on the power reduction performed in step S103. Based on the report, the base station may recognize that the transmit power designated in step S101 exceeds P_{CMAX, c} to perform subsequent control.

In step S105, the UE transmits a signal. In the case of passing through step S103, transmit power of the signal is the reduced transmit power. In the case where a result of the determination in step S102 is false (No), transmit power of the signal may be the transmit power designated by the above-mentioned transmit power designation information, and the UE may not report the power reduction information.

According to the processing as shown in FIG. 2, the base station designates transmit power of a given signal of the UE, receives a report of the power reduction information when the UE performs power reduction, and therefore, is capable of suitably grasping transmit power of the UE.

In addition, each of above-mentioned Embodiments (Embodiments 1 to 3) shows the example where the power reduction information, maximum transmit power information, transmit power designation information and the like includes information of a CC level, but the invention is not limited thereto, and the information may include information obtained by integrating a plurality of CCs. For example, the power reduction information may include power reduction information on a total power limitation value obtained by summarizing transmit power reduction values of all CCs. The above-mentioned P_{CMAX, c}, P_{CMAX_L, c}, P_{CMAX_H, c}, and the like may be read with P_{CMAX}, P_{CMAX_L}, P_{CMAX_H}, and the like with respect to total transmit power, respectively.

Each of above-mentioned Embodiments (Embodiments 1 to 3) may be applied to beam specific power control, waveform specific power control, service type specific power control and the like. In each of above-mentioned Embodiments, the power reduction information, maximum transmit power information, transmit power designation information and the like may be beam specific information, waveform specific information, service type specific information and the like. For example, the beam specific information may be information differing corresponding to an applied transmission beam.

In other words, the “CC” in the description of each of above-mentioned Embodiments (Embodiments 1 to 3) may be read with a “beam”, “waveform” “service type” and the like. As one example, the power reduction information may include power reduction information for each beam (or on a particular beam), may include power reduction information common to a plurality of beams, or may include power reduction information obtained by integrating a plurality of beams.

In beam specific power control, it is possible to perform power control on a beam-by-beam basis. In addition, the “beam” may be read with a waveform, layer, layer group, panel, beam group, beam pair link, service type and the like.

In waveform specific power control, it is possible to perform power control for each of respective waveforms based on different transmission schemes (may be called a multiplexing scheme, modulation scheme, access scheme, waveform scheme and the like). For example, it may be possible to expect a cyclic prefix OFDM (CP-OFDM: Cyclic Prefix Orthogonal Frequency Division Multiplexing)-based waveform, DFT-S-OFDM (Discrete Fourier Transform Spread Orthogonal Frequency Division Multiplexing)-based waveform and the like.

In the service type, it is possible to perform power control on a service-type-by-service-type basis. As the service type, for example, it may be possible to expect enhanced Mobile Broad Band (eMBB), massive Machine Type Communication (mMTC), Ultra Reliable and Low Latency communications (URLLC) and the like.

### (Radio Communication System)

A configuration of a radio communication system according to one Embodiment of the present disclosure will be described below. In the radio communication system, communication is performed using one or combination of the radio communication methods according to each of the above-mentioned Embodiments of the present disclosure.

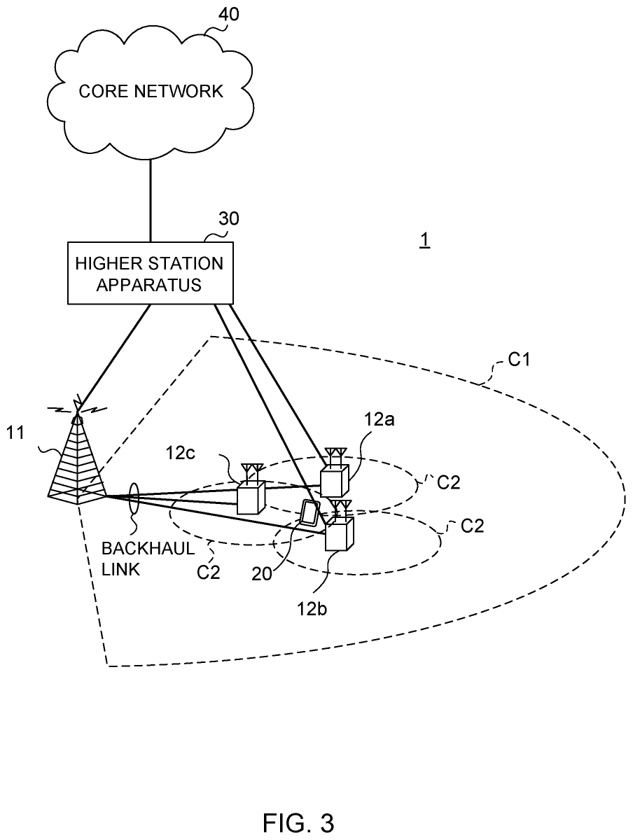

FIG. 3 is a diagram showing one example of a schematic configuration of the radio communication system according to one Embodiment. In the radio communication system 1, it is possible to apply carrier aggregation (CA) to aggregate a plurality of base frequency blocks (component carriers) with a system bandwidth (e.g., 20 MHz) of the LTE system as one unit and/or dual connectivity (DC).

In addition, the radio communication system 1 may be called Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), New Radio (NR), Future Radio Access (FRA), New-RAT (Radio Access Technology) and the like, or systems for actualizing these systems.

The radio communication system 1 is provided with a radio base station 11 for forming a macrocell C1 with relatively wide coverage, and radio base stations 12 (12a-12c) disposed inside the macrocell C1 to form small cells C2 narrower than the macrocell C1. Further, a user terminal 20 is disposed in the macrocell C1 and each of the small cells C2. The arrangement, the numbers and the like of each cell and user terminal 20 are not limited to the aspect shown in the figure.

The user terminal 20 is capable of connecting to both the radio base station 11 and the radio base station 12. The user terminal 20 is assumed to concurrently use the macrocell C1 and small cell C2 using CA or DC. Further, the user terminal 20 may apply CA or DC using a plurality of cells (CCs) (e.g., 5 CCs or less, 6 CCs or more).

The user terminal 20 and radio base station 11 are capable of communicating with each other using carriers (called the existing carrier, legacy carrier and the like) with a narrow bandwidth in a relatively low frequency band (e.g., 2 GHz). On the other hand, the user terminal 20 and radio base station 12 may use carriers with a wide bandwidth in a relatively high frequency band (e.g., 3.5 GHz, 5 GHz, etc.), or may use the same carrier as in the radio base station 11. In addition, the configuration of the frequency band used in each radio base station is not limited thereto.

Further, the user terminal 20 is capable of performing communication in each cell, using Time Division Duplex (TDD) and/or Frequency Division Duplex (FDD). Furthermore, in each cell (carrier), single numerology may be applied, or a plurality of different types of numerology may be applied.

The numerology may be a communication parameter applied to transmission and/or reception of some signal and/or channel, and for example, may indicate at least one of subcarrier spacing (SCS: Sub-Carrier Spacing), bandwidth, symbol length, cyclic prefix length, subframe length, transmission time interval (TTI) length (e.g., slot length), the number of symbols per TTI, radio frame configuration, filtering processing, windowing processing and the like.

The radio base station 11 and radio base station 12 (or, two radio base stations 12) may undergo wired connection (e.g., optical fiber in conformity with CPRI (Common Public Radio Interface), X2 interface, etc.), or wireless connection.

The radio base station 11 and each of the radio base stations 12 are respectively connected to a higher station apparatus 30, and are connected to a core network 40 via the higher station apparatus 30. In addition, for example, the higher station apparatus 30 includes an access gateway apparatus, Radio Network Controller (RNC), Mobility Management Entity (MME) and the like, but is not limited thereto. Further, each of the radio base stations 12 may be connected to the higher station apparatus 30 via the radio base station 11.

In addition, the radio base station 11 is a radio base station having relatively wide coverage, and may be called a macro base station, collection node, eNodeB (eNB), transmission and reception point and the like. Further, the radio base station 12 is a radio base station having local coverage, and may be called a small base station, micro-base station, pico-base station, femto-base station, Home eNodeB (HeNB), Remote Radio Head (RRH), transmission and reception point and the like. Hereinafter, in the case of not distinguishing between the radio base stations 11 and 12, the stations are collectively called a radio base station 10.

Each user terminal 20 is a terminal supporting various communication schemes such as LTE and LTE-A, and may include a fixed communication terminal (fixed station), as well as the mobile communication terminal (mobile station).

In the radio communication system 1, as radio access schemes, Orthogonal Frequency Division Multiple Access (OFDMA) is applied on downlink, and Single Carrier Frequency Division Multiple Access (SC-FDMA) and/or OFDMA is applied on uplink.

OFDMA is a multicarrier transmission scheme for dividing a frequency band into a plurality of narrow frequency bands (subcarriers), and mapping data to each subcarrier to perform communication. SC-FDMA is a single-carrier transmission scheme for dividing a system bandwidth into bands comprised of one or contiguous resource blocks for each terminal so that a plurality of terminals uses mutually different bands, and thereby reducing interference among terminals. In addition, uplink and downlink radio access schemes are not limited to the combination of the schemes, and another radio access scheme may be used.

As downlink channels, in the radio communication system 1 are used a downlink shared channel (PDSCH: Physical Downlink Shared Channel) shared by user terminals 20, broadcast channel (PBCH: Physical Broadcast Channel), downlink L1/L2 control channels and the like. User data, higher layer control information, System Information Block (SIB) and the like are transmitted on the PDSCH. Further, Master Information Block (MIB) is transmitted on the PBCH.

The downlink L1/L2 control channel includes Physical Downlink Control Channel (PDCCH), Enhanced Physical Downlink Control channel (EPDCCH), Physical Control Format Indicator Channel (PCFICH), Physical Hybrid-ARQ Indicator Channel (PHICH) and the like. The downlink control information (DCI) including scheduling information of the PDSCH and/or PUSCH and the like is transmitted on the PDCCH.

In addition, the scheduling information may be notified using DCI. For example, DCI for scheduling DL data reception may be called DL assignment, and DCI for scheduling UL data transmission may be called UL grant.

The number of OFDM symbols used in the PDCCH is transmitted on the PCFICH. The PHICH carries receipt confirmation information (e.g., also referred to as retransmission control information, HARQ-ACK, ACK/NACK, etc.) of HARQ (Hybrid Automatic Repeat reQuest) in response to the PUSCH. The EPDCCH is frequency division multiplexed with the PDSCH (downlink shared channel) to be used in transmitting the DCI and the like as the PDCCH.

As uplink channels, in the radio communication system 1 are used an uplink shared channel (PUSCH: Physical Uplink Shared Channel) shared by user terminals 20, uplink control channel (PUCCH: Physical Uplink Control Channel), random access channel (PRACH: Physical Random Access Channel) and the like. User data, higher layer control information and the like is transmitted on the PUSCH. Further, the PUCCH carries the radio quality information (CQI: Channel Quality Information) of downlink, receipt confirmation information, scheduling request (SR) and the like. A random access preamble to establish connection with the cell is transmitted on the PRACH.

As downlink reference signals, in the radio communication system 1 are transmitted Cell-specific Reference signal (CRS), Channel State Information-Reference Signal (CSI), DeModulation Reference Signal (DMRS), Positioning Reference Signal (PRS) and the like. Further, as uplink reference signals, in the radio communication system 1 are transmitted Sounding Reference Signal (SRS), DeModulation Reference Signal (DMRS) and the like. In addition, the DMRS may be called a UE-specific Reference Signal. Further, transmitted reference signals are not limited thereto.

### (Radio Base Station)

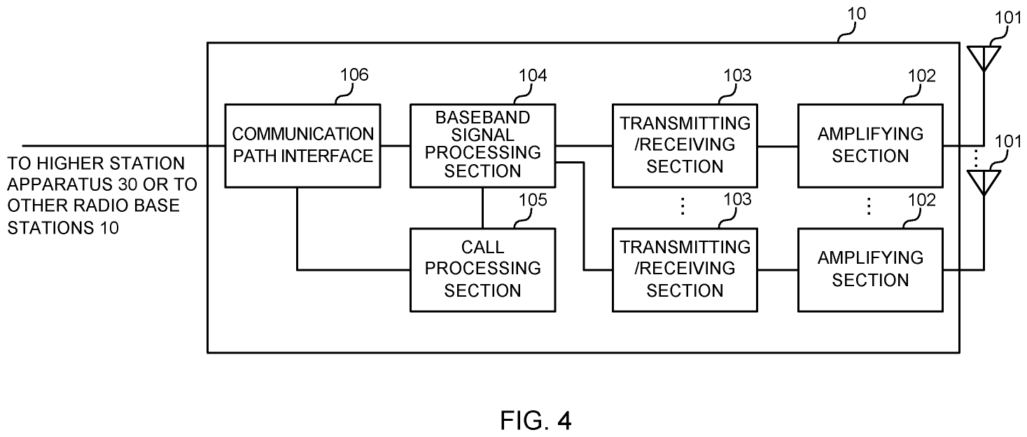

FIG. 4 is a diagram showing one example of an entire configuration of the radio base station according to one Embodiment. The radio base station 10 is provided with a plurality of transmitting/receiving antennas 101, amplifying sections 102, transmitting/receiving sections 103, baseband signal processing section 104, call processing section 105, and communication path interface 106. In addition, with respect to each of the transmitting/receiving antenna 101, amplifying section 102, and transmitting/receiving section 103, the radio base station may be configured to include at least one or more.

User data to transmit to the user terminal 20 from the radio base station 10 on downlink is input to the baseband signal processing section 104 from the higher station apparatus 30 via the communication path interface 106.

The baseband signal processing section 104 performs, on the user data, transmission processing such as processing of PDCP (Packet Data Convergence Protocol) layer, segmentation and concatenation of the user data, transmission processing of RLC (Radio Link Control) layer such as RLC retransmission control, MAC (Medium Access Control) retransmission control (e.g., processing of HARQ), scheduling, transmission format selection, channel coding, Inverse Fast Fourier Transform (IFFT) processing and precoding processing to transfer to the transmitting/receiving sections 103. Further, also concerning a downlink control signal, the section 104 performs transmission processing such as channel coding and Inverse Fast Fourier Transform on the signal to transfer to the transmitting/receiving sections 103.

Each of the transmitting/receiving sections 103 converts the baseband signal, which is subjected to precoding for each antenna and is output from the baseband signal processing section 104, into a signal with a radio frequency band to transmit. The radio-frequency signal subjected to frequency conversion in the transmitting/receiving section 103 is amplified in the amplifying section 102, and is transmitted from the transmitting/receiving antenna 101. The transmitting/receiving section 103 is capable of being comprised of a transmitter/receiver, transmitting/receiving circuit or transmitting/receiving apparatus explained based on common recognition in the technical field according to the present disclosure. In addition, the transmitting/receiving section 103 may be comprised as an integrated transmitting/receiving section, or may be comprised of a transmitting section and receiving section.

On the other hand, for uplink signals, radio-frequency signals received in the transmitting/receiving antennas 101 are amplified in the amplifying sections 102. The transmitting/receiving section 103 receives the uplink signal amplified in the amplifying section 102. The transmitting/receiving section 103 performs frequency conversion on the received signal into a baseband signal to output to the baseband signal processing section 104.

For user data included in the input uplink signal, the baseband signal processing section 104 performs Fast Fourier Transform (FFT) processing, Inverse Discrete Fourier Transform (IDFT) processing, error correcting decoding, reception processing of MAC retransmission control, and reception processing of RLC layer and PDCP layer to transfer to the higher station apparatus 30 via the communication path interface 106. The call processing section 105 performs call processing (configuration, release, etc.) of a communication channel, state management of the radio base station 10, and management of radio resources.

The communication path interface 106 transmits and receives signals to/from the higher station apparatus 30 via a given interface. Further, the communication path interface 106 may transmit and receive signals (backhaul signaling) to/from another adjacent radio base station 10 via an inter-base station interface (e.g., optical fiber in conformity with Common Public Radio Interface (CPRI), X2 interface).

In addition, the transmitting/receiving section 103 may further have an analog beam forming section for performing analog beam forming. The analog beam forming section may be comprised of an analog beam forming circuit (e.g., phase shifter, phase shift circuit) or analog beam forming apparatus (e.g., phase shift device) explained based on the common recognition in the technical field according to the present disclosure. Further, for example, the transmitting/receiving antenna 101 may be comprised of an array antenna.

The transmitting/receiving section 103 may receive a given signal transmitted from the user terminal 20 using transmit power applied with power reduction.

The transmitting/receiving section 103 may receive the power reduction information, maximum transmit power information, PHR and the like. In the case of receiving the power reduction information on a given carrier, the transmitting/receiving section 103 may not assume reception of information on P_{CMAX, c} about the given carrier.

The transmitting/receiving section 103 may transmit, to the user terminal 20, a report instruction for the power reduction information, report instruction for the maximum transmit power information, transmit power designation information, TPC command and the like.

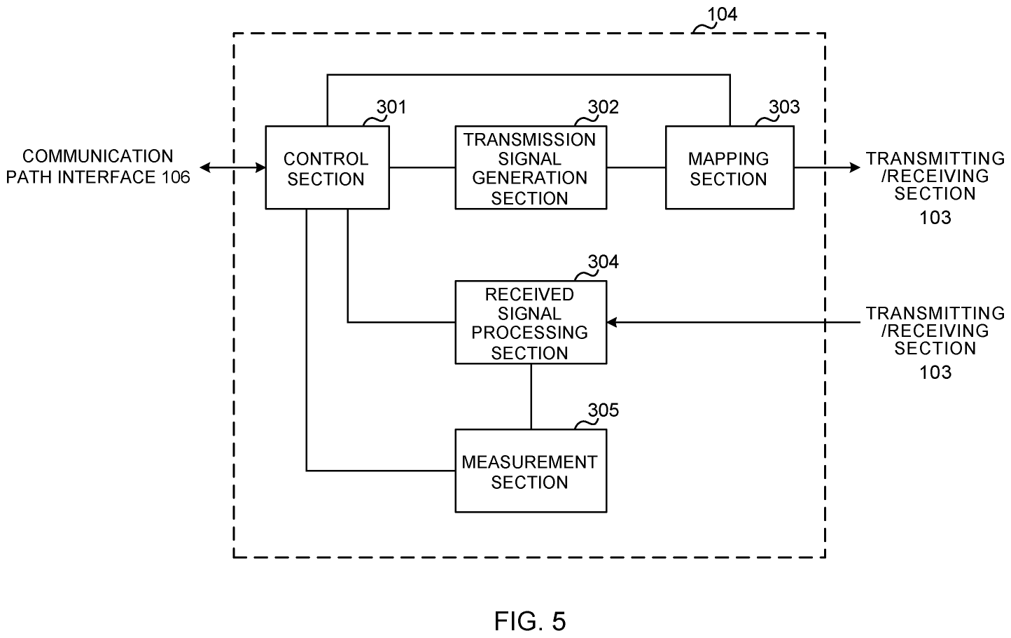

FIG. 5 is a diagram showing one example of a function configuration of the radio base station according to one Embodiment. In addition, this example mainly illustrates function blocks of a characteristic portion in this Embodiment, and the radio base station 10 may be assumed to have other function blocks required for radio communication.

The baseband signal processing section 104 is provided with at least a control section (scheduler) 301, transmission signal generating section 302, mapping section 303, received signal processing section 304, and measurement section 305. In addition, it is essential only that these components are included in the radio base station 10, and a part or the whole of components may not be included in the baseband signal processing section 104.

The control section (scheduler) 301 performs control of the entire radio base station 10. The control section 301 is capable of being comprised of a controller, control circuit or control apparatus explained based on the common recognition in the technical field according to the present disclosure.

For example, the control section 301 controls generation of signals in the transmission signal generating section 302, allocation of signals in the mapping section 303 and the like. Further, the control section 301 controls reception processing of signals in the received signal processing section 304, measurement of signals in the measurement section 305 and the like.

The control section 301 controls scheduling (e.g., resource allocation) of system information, downlink data signal (e.g., signal transmitted on the PDSCH), and downlink control signal (e.g., signal transmitted on the PDCCH and/or EPDCCH, receipt confirmation information, etc.). Further, the control section 301 controls generation of the downlink control signal, downlink data signal and the like, based on a result obtained by determining necessity of retransmission control to the uplink data signal and the like. Furthermore, the control section 301 controls scheduling of synchronization signals (e.g., Primary Synchronization Signal (PSS)/Secondary Synchronization Signal (SSS)), downlink reference signal (e.g., CRS, CSI-RS, DMRS) and the like.

Further, the control section 301 controls scheduling of the uplink data signal (e.g., signal transmitted on the PUSCH), uplink control signal (e.g., signal transmitted on the PUCCH and/or PUSCH, receipt confirmation information, etc.), random access preamble (e.g., signal transmitted on the PRACH), uplink reference signal and the like.

The control section 301 may control to transmit, to the user terminal 20, at least one of a report instruction for the power reduction information, report instruction for the maximum transmit power information, and transmit power designation information.

Based on the PHR, power reduction information, maximum transmit power information and the like received from the user terminal 20, the control section 301 may judge transmit power of the user terminal 20 and/or power reduction applied by the user terminal 20.

Based on instructions from the control section 301, the transmission signal generating section 302 generates downlink signals (downlink control signal, downlink data signal, downlink reference signal, etc.) to output to the mapping section 303. The transmission signal generating section 302 is capable of being comprised of a signal generator, signal generating circuit or signal generating apparatus explained based on the common recognition in the technical field according to the present disclosure.

For example, based on instructions from the control section 301, the transmission signal generating section 302 generates DL assignment for notifying of downlink data assignment information and/or UL grant for notifying of uplink data assignment information. Each of the DL assignment and UL grant is the DCI, and conforms to a DCI format. Further, the downlink data signal undergoes coding processing and modulation processing according to a coding rate, modulation scheme and the like determined based on the channel state information (CSI) from each user terminal 20 and the like.

Based on instructions from the control section 301, the mapping section 303 maps the downlink signal generated in the transmission signal generating section 302 to given radio resources to output to the transmitting/receiving section 103. The mapping section 303 is capable of being comprised of a mapper, mapping circuit or mapping apparatus explained based on the common recognition in the technical field according to the present disclosure.

The received signal processing section 304 performs reception processing (e.g., demapping, demodulation, decoding, etc.) on the received signal input from the transmitting/receiving section 103. Herein, for example, the received signal is the uplink signal (uplink control signal, uplink data signal, uplink reference signal, etc.) transmitted from the user terminal 20. The received signal processing section 304 is capable of being comprised of a signal processor, signal processing circuit or signal processing apparatus explained based on the common recognition in the technical field according to the present invention.

The received signal processing section 304 outputs information decoded by the reception processing to the control section 301. For example, in the case of receiving the PUCCH including HARQ-ACK, the section 304 outputs the HARQ-ACK to the control section 301. Further, the received signal processing section 304 outputs the received signal and/or signal subjected to the reception processing to the measurement section 305.

The measurement section 305 performs measurement on the received signal. The measurement section 305 is capable of being comprised of a measurement device, measurement circuit or measurement apparatus explained based on the common recognition in the technical field according to the present disclosure.

For example, based on the received signal, the measurement section 305 may perform Radio Resource Management (RRM) measurement, Channel State Information (CSI) measurement and the like. The measurement section 305 may measure received power (e.g., Reference Signal Received Power (RSRP)), received quality (e.g., Reference Signal Received Quality (RSRQ), Signal to Interference plus Noise Ratio (SINR), Signal to Noise Ratio (SNR)), signal strength (e.g., Received Signal Strength Indicator (RSSI)), propagation path information (e.g., CSI) and the like. The measurement result may be output to the control section 301.

### (User Terminal)

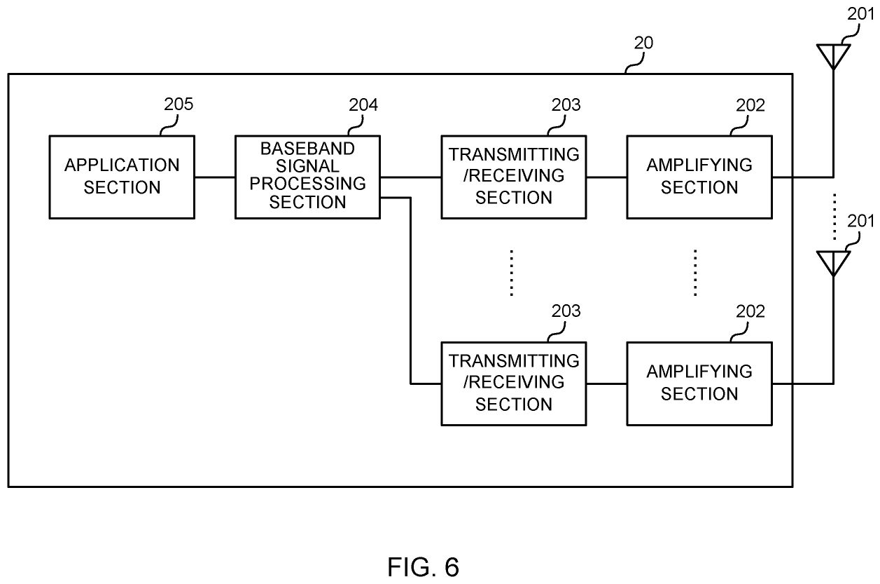

FIG. 6 is a diagram showing one example of an entire configuration of the user terminal according to one Embodiment. The user terminal 20 is provided with a plurality of transmitting/receiving antennas 201, amplifying sections 202, transmitting/receiving sections 203, baseband signal processing section 204, and application section 205. In addition, with respect to the transmitting/receiving antenna 201, amplifying section 202 and transmitting/receiving section 203, the user terminal 20 may be configured to include at least one or more.

Radio-frequency signals received in a plurality of transmitting/receiving antennas 201 are respectively amplified in the amplifying sections 202. Each of the transmitting/receiving sections 203 receives the downlink signal amplified in the amplifying section 202. The transmitting/receiving section 203 performs frequency conversion on the received signal into a baseband signal to output to the baseband signal processing section 204. The transmitting/receiving section 203 is capable of being comprised of a transmitter/receiver, transmitting/receiving circuit or transmitting/receiving apparatus explained based on the common recognition in the technical field according to the present disclosure. The transmitting/receiving section 203 may be comprised as an integrated transmitting/receiving section, or may be comprised of a transmitting section and receiving section.

The baseband signal processing section 204 performs FFT processing, error correcting decoding, reception processing of retransmission control and the like on the input baseband signal. User data on downlink is transferred to the application section 205. The application section 205 performs processing concerning layers higher than the physical layer and MAC layer, and the like. Further, among the data on downlink, broadcast information may also be transferred to the application section 205.

On the other hand, for user data on uplink, the data is input to the baseband signal processing section 204 from the application section 205. The baseband signal processing section 204 performs, on the data, transmission processing (e.g., transmission processing of HARQ) of retransmission control, channel coding, precoding, Discrete Fourier Transform (DFT) processing, IFFT processing and the like to transfer to each of the transmitting/receiving sections 203. Each of the transmitting/receiving sections 203 converts the baseband signal output from the baseband signal processing section 204 into a signal with a radio frequency band to transmit. The radio-frequency signals subjected to frequency conversion in the transmitting/receiving sections 203 are amplified in the amplifying sections 202, and are transmitted from the transmitting/receiving antennas 201, respectively.

In addition, the transmitting/receiving section 203 may further have an analog beam forming section for performing analog beam forming. The analog beam forming section may be comprised of an analog beam forming circuit (e.g., phase shifter, phase shift circuit) or analog beam forming apparatus (e.g., phase shift device) explained based on the common recognition in the technical field according to the present disclosure. Further, the transmitting/receiving antenna 201 may be comprised of an array antenna.

The transmitting/receiving section 203 may transmit, to the radio base station 10, a given signal using transmit power applied with power reduction by a control section 401 described later.

The transmitting/receiving section 203 may transmit the power reduction information, maximum transmit power information, PHR and the like. In the case of transmitting the power reduction information on a given carrier, the transmitting/receiving section 203 may not transmit information on P_{CMAX, c} about the given carrier.

The transmitting/receiving section 203 may receive, from the base station 10, the report instruction for the power reduction information, report instruction for the maximum transmit power information, transmit power designation information, TPC command and the like.

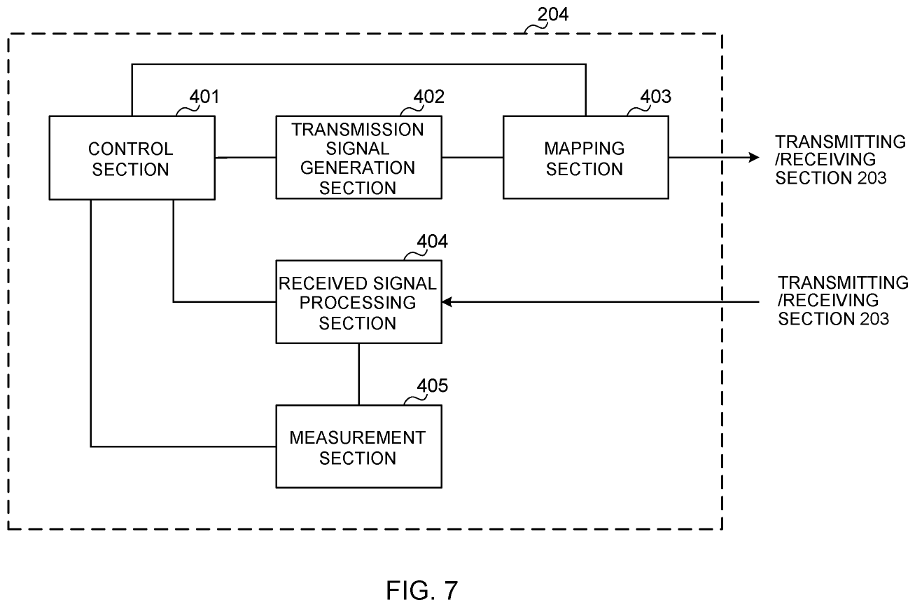

FIG. 7 is a diagram showing one example of a function configuration of the user terminal according to one Embodiment. In addition, this example mainly illustrates function blocks of a characteristic portion in this Embodiment, and the user terminal 20 may be assumed to have other function blocks required for radio communication.

The baseband signal processing section 204 that the user terminal 20 has is provided with at least the control section 401, transmission signal generating section 402, mapping section 403, received signal processing section 404, and measurement section 405. In addition, it is essential only that these components are included in the user terminal 20, and a part or the whole of components may not be included in the baseband signal processing section 204.

The control section 401 performs control of the entire user terminal 20. The control section 401 is capable of being comprised of a controller, control circuit or control apparatus explained based on the common recognition in the technical field according to the present disclosure.

For example, the control section 401 controls generation of signals in the transmission signal generating section 402, allocation of signals in the mapping section 403 and the like. Further, the control section 401 controls reception processing of signals in the received signal processing section 404, measurement of signals in the measurement section 405 and the like.

The control section 401 acquires the downlink control signal and downlink data signal transmitted from the radio base station 10, from the received signal processing section 404. Further, the control section 401 controls generation of the uplink control signal and/or uplink data signal, based on a result obtained by determining necessity of retransmission control to the downlink control signal and/or downlink data signal and the like.

The control section 401 may perform transmit power control of a signal to transmit. For example, the control section 401 may apply power reduction to transmit power in a given carrier. Based on the transmit power designation information notified from the radio base station 10, the control section 401 may apply the above-mentioned power reduction.

Further, in the case of acquiring various pieces of information notified from the radio base station 10, from the received signal processing section 404, based on the information, the control section 401 may update a parameter used in control.

Based on instructions from the control section 401, the transmission signal generating section 402 generates uplink signals (uplink control signal, uplink data signal, uplink reference signal, etc.) to output to the mapping section 403. The transmission signal generating section 402 is capable of being comprised of a signal generator, signal generating circuit or signal generating apparatus explained based on the common recognition in the technical field according to the present disclosure.

For example, based on instructions from the control section 401, the transmission signal generating section 401 generates the uplink control signal about the receipt confirmation information, channel state information (CSI) and the like. Further, based on instructions from the control section 401, the transmission signal generating section 402 generates an uplink data signal. For example, when the downlink control signal notified from the radio base statin 10 includes a UL grant, the transmission signal generating section 402 is instructed to generate the uplink data signal from the control section 401.

Based on instructions from the control section 401, the mapping section 403 maps the uplink signal generated in the transmission signal generating section 402 to radio resources to output to the transmitting/receiving section 203. The mapping section 403 is capable of being comprised of a mapper, mapping circuit or mapping apparatus explained based on the common recognition in the technical field according to the present disclosure.

The received signal processing section 404 performs reception processing (e.g., demapping, demodulation, decoding, etc.) on the received signal input from the transmitting/receiving section 203. Herein, for example, the received signal is the downlink signal (downlink control signal, downlink data signal, downlink reference signal, etc.) transmitted from the radio base station 10. The received signal processing section 404 is capable of being comprised of a signal processor, signal processing circuit or signal processing apparatus explained based on the common recognition in the technical field according to the present disclosure. Further, the received signal processing section 404 is capable of constituting the receiving section according to the present disclosure.

The received signal processing section 404 outputs information decoded by the reception processing to the control section 401. For example, the received signal processing section 404 outputs, to the control section 401, broadcast information, system information, RRC signaling, DCI and the like. Further, the received signal processing section 404 outputs the received signal and/or signal subjected to the reception processing to the measurement section 405.

The measurement section 405 performs measurement on the received signal. The measurement section 405 is capable of being comprised of a measurement device, measurement circuit or measurement apparatus explained based on the common recognition in the technical field according to the present disclosure.

For example, based on the received signal, the measurement section 405 may perform RRM measurement, CSI measurement and the like. The measurement section 405 may measure received power (e.g., RSRP), received quality (e.g., RSRQ, SINR, SNR), signal strength (e.g., RSSI), propagation path information (e.g., CSI) and the like. The measurement result may be output to the control section 401.

### (Hardware Configuration)

In addition, the block diagrams used in explanation of the above-mentioned Embodiment show blocks on a function-by-function basis. These function blocks (configuration sections) are actualized by any combination of hardware and/or software. Further, the means for actualizing each function block is not limited particularly. In other words, each function block may be actualized using a single apparatus combined physically and/or logically, or two or more apparatuses that are separated physically and/or logically are connected directly and/or indirectly (e.g., using cable and/or radio), and each function block may be actualized using a plurality of these apparatuses.

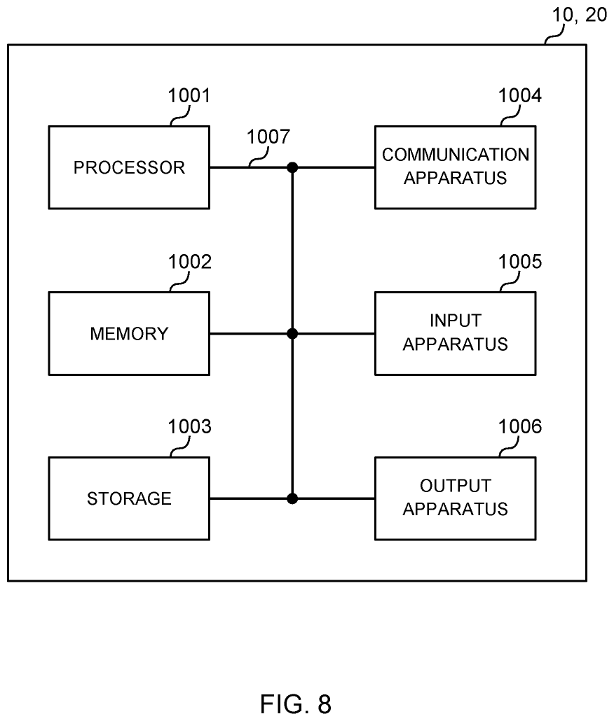

For example, each of the radio base station, user terminal and the like in one Embodiment may function as a computer that performs the processing of the radio communication method shown in the present disclosure. FIG. 8 is a diagram showing one example of a hardware configuration of each of the radio base station and user terminal according to one Embodiment. Each of the radio base station 10 and user terminal 20 as described above may be physically configured as a computer apparatus including a processor 1001, memory 1002, storage 1003, communication apparatus 1004, input apparatus 1005, output apparatus 1006, bus 1007 and the like.

In addition, in the following description, it is possible to replace the letter of “apparatus” with a circuit, device, unit and the like to read. With respect to each apparatus shown in the figure, the hardware configuration of each of the radio base station 10 and the user terminal 20 may be configured so as to include one or a plurality of apparatuses, or may be configured without including a part of apparatuses.

For example, a single processor 1001 is shown in the figure, but a plurality of processors may exist. Further, the processing may be executed by a single processor, or may be executed by one or more processors at the same time, sequentially or using another technique. In addition, the processor 1001 may be implemented on one or more chips.

For example, each function in the radio base station 10 and user terminal 20 is actualized in a manner such that given software (program) is read on the hardware of the processor 1001, memory 1002 and the like, and that the processor 1001 thereby performs computations, and controls communication via the communication apparatus 1004, and read and/or write of data in the memory 1002 and storage 1003.

For example, the processor 1001 operates an operating system to control the entire computer. The processor 1001 may be comprised of a Central Processing Unit (CPU) including interfaces with peripheral apparatuses, control apparatus, computation apparatus, register and the like. For example, the above-mentioned baseband signal processing section 104 (204), call processing section 105 and the like may be actualized by the processor 1001.

Further, the processor 1001 reads the program (program code), software module, data and the like on the memory 1002 from the storage 1003 and/or the communication apparatus 1004, and according thereto, executes various kinds of processing. Used as the program is a program that causes the computer to execute at least a part of operation described in the above-mentioned Embodiment. For example, the control section 401 of the user terminal 20 may be actualized by a control program stored in the memory 1002 to operate in the processor 1001, and the other function blocks may be actualized similarly.

The memory 1002 is a computer-readable storage medium, and for example, may be comprised of at least one of Read Only Memory (ROM), Erasable Programmable ROM (EPROM), Electrically EPROM (EEPROM), Random Access Memory (RAM) and other proper storage media. The memory 1002 may be called the register, cache, main memory (main storage apparatus) and the like. The memory 1002 is capable of storing the program (program code), software module and the like executable to implement the radio communication method according to one Embodiment.

The storage 1003 is a computer-readable storage medium, and for example, may be comprised of at least one of a flexible disk, floppy (Registered Trademark) disk, magneto-optical disk (e.g., compact disk (CD-ROM (Compact Disc ROM), etc.), digital multi-purpose disk, Blu-ray (Registered Trademark) disk), removable disk, hard disk drive, smart card, flash memory device (e.g., card, stick, key drive), magnetic stripe, database, server and other proper storage media. The storage 1003 may be called an auxiliary storage apparatus.

The communication apparatus 1004 is hardware (transmitting/receiving device) to perform communication between computers via a wired and/or wireless network, and for example, is also referred to as a network device, network controller, network card, communication module and the like. For example, in order to actualize Frequency Division Duplex (FDD) and/or Time Division Duplex (TDD), the communication apparatus 1004 may be comprised by including a high-frequency switch, duplexer, filter, frequency synthesizer and the like. For example, the transmitting/receiving antenna 101 (201), amplifying section 102 (202), transmitting/receiving section 103 (203), communication path interface 106 and the like as described above may be actualized by the communication apparatus 1004.

The input apparatus 1005 is an input device (e.g., keyboard, mouse, microphone, switch, button, sensor, etc.) that receives input from the outside. The output apparatus 1006 is an output device (e.g., display, speaker, LED (Light Emitting Diode) lamp, etc.) that performs output to the outside. In addition, the input apparatus 1005 and output apparatus 1006 may be an integrated configuration (e.g., touch panel).

Further, each apparatus of the processor 1001, memory 1002 and the like is connected on the bus 1007 to communicate information. The bus 1007 may be configured using a single bus, or may be configured using different buses between apparatuses.

Furthermore, each of the radio base station 10 and user terminal 20 may be configured by including hardware such as a microprocessor, Digital Signal Processor (DSP), Application Specific Integrated Circuit (ASIC), Programmable Logic Device (PLD), and Field Programmable Gate Array (FPGA), or a part or the whole of each function block may be actualized using the hardware. For example, the processor 1001 may be implemented using at least one of the hardware.

### (Modification)

In addition, the term explained in the present Description and/or the term required to understand the present Description may be replaced with a term having the same or similar meaning. For example, the channel and/or the symbol may be a signal (signaling). Further, the signal may be a message. The reference signal is capable of being abbreviated as RS (Reference Signal), and according to the standard to apply, may be called a pilot, pilot signal and the like. Furthermore, the component carrier (CC) may be called a cell, frequency carrier, carrier frequency and the like.

Further, a radio frame may be comprised of one or a plurality of frames in the time domain. The one or each of the plurality of frames constituting the radio frame may be called a subframe. Furthermore, the subframe may be comprised of one or a plurality of slots in the time domain. The subframe may be a fixed time length (e.g., 1 ms) that is not dependent on numerology.

Furthermore, the slot may be comprised of one or a plurality of symbols (Orthogonal Frequency Division Multiplexing (OFDM) symbols, Single Carrier Frequency Division Multiple Access (SC-FDMA) symbols and the like) in the time domain. Still furthermore, the slot may a time unit based on numerology. Moreover, the slot may include a plurality of mini slots. Each mini slot may be comprised of one or a plurality of symbols in the time domain. Further, the mini slot may be called a subslot.

Each of the radio frame, subframe, slot, mini slot and symbol represents a time unit in transmitting a signal. For the radio frame, subframe, slot, mini slot and symbol, another name corresponding to each of them may be used. For example, one subframe may be called Transmission Time Interval (TTI), a plurality of contiguous subframes may be called TTI, or one slot or one mini slot may be called TTI. In other words, the subframe and/or TTI may be the subframe (1 ms) in existing LTE, may be a frame (e.g., 1 to 13 symbols) shorter than 1 ms, or may be a frame longer than 1 ms. In addition, instead of the subframe, the unit representing the TTI may be called the slot, mini slot and the like.

Herein, for example, the TTI refers to a minimum time unit of scheduling in radio communication. For example, in the LTE system, the radio base station performs scheduling for allocating radio resources (frequency bandwidth, transmit power and the like capable of being used in each user terminal) to each user terminal in a TTI unit. In addition, the definition of the TTI is not limited thereto.

The TTI may be a transmission time unit of a data packet (transport block) subjected to channel coding, code block and/or codeword, or may be a processing unit of scheduling, link adaptation and the like. In addition, when the TTI is given, a time segment (e.g., the number of symbols) to which the transport block, code block and/or codeword is actually mapped may be shorter than the TTI.

In addition, when one slot or one mini slot is called the TTI, one or more TTIs (i.e., one or more slots, or one or more mini slots) may be the minimum time unit of scheduling. Further, the number of slots (the number of mini slots) constituting the minimum time unit of scheduling may be controlled.

The TTI having a time length of 1 ms may be called ordinary TTI (TTI in LTE Rel.8-12), normal TTI, long TTI, ordinary subframe, normal subframe, long subframe or the like. The TTI shorter than the ordinary TTI may be called shortened TTI, short TTI, partial or fractional TTI, shortened subframe, short subframe, mini slot, subslot or the like.

In addition, the long TTI (e.g., ordinary TTI, subframe, etc.) may be read with TTI having a time length exceeding 1 ms, and the short TTI (e.g., shortened TTI, etc.) may be read with TTI having a TTI length of 1 ms or more and less than the TTI length of the long TTI.

The resource block (RB) is a resource allocation unit in the time domain and frequency domain, and may include one or a plurality of contiguous subcarriers in the frequency domain. Further, the RB may include one or a plurality of symbols in the time domain, and may be a length of 1 slot, 1 mini slot, 1 subcarrier, or 1 TTI. Each of 1 TTI and 1 subframe may be comprised of one or a plurality of resource blocks. In addition, one or a plurality of RBs may be called a physical resource block (PRB: Physical RB), subcarrier group (SCG: Sub-Carrier Group), resource element group (REG), PRB pair, RB pair and the like.

Further, the resource block may be comprised of one or a plurality of resource elements (RE: Resource Element). For example, 1 RE may be a radio resource region of 1 subcarrier and 1 symbol.

In addition, structures of the above-mentioned radio frame, subframe, slot, mini slot, symbol and the like are only illustrative. For example, it is possible to modify, in various manners, configurations of the number of subframes included in the radio frame, the number of slots per subframe or radio frame, the number of mini slots included in the slot, the numbers of symbols and RBs included in the slot or mini slot, the number of subcarriers included in the RB, the number of symbols within the TTI, the symbol length, the cyclic prefix (CP) length and the like.

Further, the information, parameter and the like explained in the present Description may be expressed using an absolute value, may be expressed using a relative value from a given value, or may be expressed using another corresponding information. For example, the radio resource may be indicated by a given index.

The names used in the parameter and the like in the present Description are not restrictive names in any respects. For example, it is possible to identify various channels (Physical Uplink Control Channel (PUCCH), Physical Downlink Control Channel (PDCCH) and the like) and information elements, by any suitable names, and therefore, various names assigned to these various channels and information elements are not restrictive names in any respects.

The information, signal and the like explained in the present Description may be represented by using any of various different techniques. For example, the data, order, command, information, signal, bit, symbol, chip and the like capable of being described over the entire above-mentioned explanation may be represented by voltage, current, electromagnetic wave, magnetic field or magnetic particle, optical field or photon, or any combination thereof.

Further, the information, signal and the like are capable of being output from a higher layer to a lower layer, and/or from the lower layer to the higher layer. The information, signal and the like may be input and output via a plurality of network nodes.

The input/output information, signal and the like may be stored in a particular place (e.g., memory), or may be managed using a management table. The input/output information, signal and the like are capable of being rewritten, updated or edited. The output information, signal and the like may be deleted. The input information, signal and the like may be transmitted to another apparatus.

Notification of the information is not limited to the Aspect/Embodiment described in the present Description, and may be performed using another method. For example, notification of the information may be performed using physical layer signaling (e.g., Downlink Control Information (DCI), Uplink Control Information (UCI)), higher layer signaling (e.g., Radio Resource Control (RRC) signaling, broadcast information (Master Information Block (MIB), System Information Block (SIB) and the like), Medium Access Control (MAC) signaling), other signals, or combination thereof.

In addition, the physical layer signaling may be called L1/L2 (Layer 1/Layer 2) control information (L1/L2 control signal), L1 control information (L1 control signal) and the like. Further, the RRC signaling may be called RRC message, and for example, may be RRC connection setup (RRC Connection Setup) message, RRC connection reconfiguration (RRC Connection Reconfiguration) message, and the like. Furthermore, for example, the MAC signaling may be notified using MAC Control Element (MAC CE).

Further, notification of given information (e.g., notification of “being X”) is not limited to explicit notification, and may be performed implicitly (e.g., notification of the given information is not performed, or by notification of different information).

The decision may be made with a value (“0” or “1”) expressed by 1 bit, may be made with a Boolean value represented by true or false, or may be made by comparison with a numerical value (e.g., comparison with a given value).

Irrespective of that the software is called software, firmware, middleware, micro-code, hardware descriptive term, or another name, the software should be interpreted widely to mean a command, command set, code, code segment, program code, program, sub-program, software module, application, software application, software package, routine, sub-routine, object, executable file, execution thread, procedure, function and the like.

Further, the software, command, information and the like may be transmitted and received via a transmission medium. For example, when the software is transmitted from a website, server or another remote source using wired techniques (coaxial cable, optical fiber cable, twisted pair, Digital Subscriber Line (DSL) and the like) and/or wireless techniques (infrared, microwave and the like), these wired techniques and/or wireless techniques are included in the definition of the transmission medium.

The terms of “system” and “network” used in the present Description are capable of being used interchangeably.

In the present Description, the terms of “Base Station (BS)”, “radio base station”, “eNB”, “gNB”, “cell”, “sector”, “cell group”, “carrier” and “component carrier” are capable of being used interchangeably. There is the case where the base station is called by the terms of fixed station, NodeB, eNodeB (eNB), access point, transmission point, reception point, femto-cell, small cell and the like.

The base station is capable of accommodating one or a plurality of (e.g., three) cells (also called the sector). When the base station accommodates a plurality of cells, the entire coverage area of the base station is capable of being segmented into a plurality of smaller areas, and each of the smaller areas is also capable of providing communication services by a base station sub-system (e.g., small base station (RRH: Remote Radio Head) for indoor use). The term of “cell” or “sector” refers to a part or the whole of coverage area of the base station and/or base station sub-system that performs communication services in the coverage.

In the present Description, the terms of “Mobile Station (MS)”, “user terminal”, “User Equipment (UE)”, and “terminal” are capable of being used interchangeably.

There is the case where the Mobile Station may be called using a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable terms.

The base station and/or mobile state may be called a transmitting apparatus, receiving apparatus and the like.

Further, the radio base station in the present Description may be read with the user terminal. For example, each Aspect/Embodiment shown in the present disclosure may be applied to a configuration where communication between the radio base station and the user terminal is replaced with communication among a plurality of user terminals (D2D: Device-to-Device). In this case, the functions that the above-mentioned radio base station 10 has may be the configuration that the user terminal 20 has. Further, the words of “up”, “down” and the like may be read with “side”. For example, the uplink channel may be read with a side channel.

Similarly, the user terminal in the present Description may be read with the radio base station. In this case, the functions that the above-mentioned user terminal 20 has may be the configuration that the radio base station 10 has.

In the present Description, operation performed by the base station is sometimes performed by an upper node thereof in some case. In a network including one or a plurality of network nodes having the base station, it is obvious that various operations performed for communication with the terminal are capable of being performed by the base station, one or more network nodes (e.g., Mobility Management Entity (MME), Serving-Gateway (S-GW) and the like are considered, but the invention is not limited thereto) except the base station, or combination thereof.

Each Aspect/Embodiment explained in the present Description may be used alone, may be used in combination, or may be switched and used according to execution. Further, with respect to the processing procedure, sequence, flowchart and the like of each Aspect/Embodiment explained in the present Description, unless there is a contradiction, the order may be changed. For example, with respect to the methods explained in the present Description, elements of various steps are presented in illustrative order, and are not limited to the presented particular order.

Each Aspect/Embodiment explained in the present Description may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), Future Radio Access (FRA), New-RAT (Radio Access Technology), New Radio (NR), New radio access (NX), Future generation radio access (FX), GSM (Registered Trademark) (Global System for Mobile communications), CDMA 2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), system using another proper radio communication method and/or the next-generation system extended based thereon.

The description of “based on” used in the present Description does not mean “based on only”, unless otherwise specified. In other words, the description of “based on” means both of “based on only” and “based on at least”.

Any references to elements using designations of “first”, “second” and the like used in the present Description do not limit the amount or order of these elements overall. These designations are capable of being used in the present Description as the useful method to distinguish between two or more elements. Accordingly, references of first and second elements do not mean that only two elements are capable of being adopted, or that the first element should be prior to the second element in any manner.

There is the case where the term of “determining” used in the present Description includes various types of operation. For example, “determining” may be regarded as “determining” calculating, computing, processing, deriving, investigating, looking up (e.g., looking up in a table, database or another data structure), ascertaining and the like. Further, “determining” may be regarded as “determining” receiving (e.g., receiving information), transmitting (e.g., transmitting information), input, output, accessing (e.g., accessing data in memory) and the like. Furthermore, “determining” may be regarded as “determining” resolving, selecting, choosing, establishing, comparing and the like. In other words, “determining” may be regarded as “determining” some operation.

The terms of “connected” and “coupled” used in the present Description or any modifications thereof mean direct or indirect every connection or coupling among two or more elements, and are capable of including existence of one or more intermediate elements between two mutually “connected” or “coupled” elements. Coupling or connection between elements may be physical, may be logical or may be combination thereof. For example, “connection” may be read with “access”.

In the present Description, in the case where two elements are connected, it is possible to consider that two elements are mutually “connected” or “coupled”, by using one or more electric wires, cable and/or print electric connection, and as some non-limited and non-inclusive examples, electromagnetic energy having wavelengths in a radio frequency region, microwave region and/or light (both visible and invisible) region, or the like.

In the present Description, the terms of “A and B are different” may mean that “A and B are different from each other”. The terms of “separate”, “coupled” and the like may be similarly interpreted.

In the case of using “including”, “comprising” and modifications thereof in the present Description or the scope of the claims, as in the term of “provided with”, these terms are intended to be inclusive. Further, the term of “or” used in the present Description or the scope of the claims is intended to be not exclusive OR.

As described above, the present invention is described in detail, but it is obvious to a person skilled in the art that the invention is not limited to the Embodiment described in the present Description. The invention is capable of being carried into practice as modified and changed aspects without departing from the subject matter and scope of the invention defined based on the descriptions of the scope of the claims. Accordingly, the descriptions of the present Description are intended for illustrative explanation, and do not provide the invention with any restrictive meaning.

1. A user terminal comprising:
a control section that applies power reduction to transmit power in a given carrier; and
a transmitting section that transmits a given signal using transmit power applied with the power reduction.

2. The user terminal according to claim 1, wherein the transmitting section further transmits information on the power reduction.

3. The user terminal according to claim 2, wherein the transmitting section does not transmit information on P_{CMAX, c} about the given carrier.

4. The user terminal according to claim 1, wherein the control section applies the power reduction, based on information for designating transmit power of the given signal notified from a base station.

5. A radio communication method in a user terminal, including:
applying power reduction to transmit power in a given carrier; and
transmitting a given signal using transmit power applied with the power reduction.

6. The user terminal according to claim 2, wherein the control section applies the power reduction, based on information for designating transmit power of the given signal notified from a base station.

7. The user terminal according to claim 3, wherein the control section applies the power reduction, based on information for designating transmit power of the given signal notified from a base station.
